(19) United States
(12) Patent Application Publication
(10) Pub. No.: US 2012/0008653 A1
(43) Pub. Date: Jan. 12, 2012

(54) Laser System with Dynamically Stabilized Transient Wavelength and Method of Operating Same

(75) Inventors: Vladimir Antonenko, Fryazino (RU); Igor Samartsew, Fryazino (RU)

(73) Assignee: IPG Photonics Corporation, Oxford, MA (US)

(21) Appl. No.: 12/833,429

(22) Filed: Jul. 9, 2010

(51) Int. Cl. H01S 3/13

(52) U.S. Cl. 372/32

(57) ABSTRACT

A method and laser system for dynamically adjusting a transient wavelength of light pulses emitted by a laser includes sequential processing of transient photocurrent curves which are generated after interaction between each light pulse and wavelength-selective medium which is configured with a known spectral peak line selected in the range of the transient wavelength. The method further includes continuously processing parameters of sequentially generated curves until the processed parameters are repeatedly uniform.

### BACKGROUND OF THE INVENTION

1. Field of the Invention

The disclosure relates to systems based on the integration of microelectronics technology and photonics. More particular, the disclosure relates to a method and system for dynamically locking a transient wavelength of lasers.

2. Discussion of the Known Art

Lasers based on the microelectronic technology, such as semiconductor laser diodes, find a broad application in several industries including, for example, telecommunication. High efficiency, compactness, long-life stability, energy-efficient structure, powering by injection of current and modulation by the same current are just a few of well-known advantages of this type of lasers which provide unlimited possibilities for the use of these devices. One of the most demanding industrial fields in need for a laser source is the Dense WDM (DWDM) fiber optic network.

The DWDM network is in need for ever-increasing number of communication channels all transmitted along a single fiber and each operating at a specific wavelength. Hence, the number of laser sources steadily grows which imposes additional and very strict requirements on a fixed output of each laser source, i.e., the wavelength (frequency). In other words, each laser is to operate at a single and stable wavelength.

The adjustment of the stabilized wavelength, typically, includes controlling the fluctuations in operating parameters of a laser including current and/or temperature. The latter is of a particular significance due mechanical deformations of the laser which, when controlled, are critical for lasing the stabilized wavelength. The temperature can be controlled either by an external heater or by current (AC or DC) which is injected into the junction of the diode, as well known to an artisan. The thermal adjustment of the transient wavelength corresponds to about 0.1 nm/degree; the latter is used as a basic premise in a laser module design.

A laser module typically includes a thermo-regulated pedestal configured as a Peltier device, a laser chip on the pedestal and a thermo-sensor detecting an environmental temperature in the module. Changing the temperature of the pedestal to control the transient lasing wavelength may be not fully effective for the stabilization of the desired wavelength because 1. the junction itself is a heat source, and 2. the injection current—the other factor affecting a transient wavelength—is not accounted for. The temperature gradient may reach tenths of degree easily translating into a margin of error reaching few hundredth of nm. This range requires frequency stabilization in order to have the desired wavelength. A single temperature sensor is not sufficient for such a task, which thus requires the use of a frequency sensor and a feedback configured to minimize the deviation of the measured frequency from a reference value.

FIG. 1¹ illustrates a wave-stabilization technique based on the comparison between a measured laser light and a reference value. In use, the output of a temperature controlled laser LD1 is coupled into a fiber FB1 and split in a fiber coupler CP1. One beam is inputted into a waveguide type acousto-optic modulator UM2 through a fiber FB3. The modulated light propagates through FB4 and further through an absorbing cell CU. As the light is coupled into the cell with a known medium, such as Cs gas, it is absorbed at a specified wavelength and an output signal, i.e., photocurrent is detected by PD1. The signal is fed back to the laser LD1 through a lock-in amplifier LA1. The oscillating frequency of the laser can be controlled in the vicinity of the center of the absorption line. The cost of acousto-optic modulators and the complexity thereof render the illustrated structure cost-inefficient, and therefore its use in telecommunication networks may be problematic. ¹ JP 63055991

FIG. 2² illustrates a further known configuration of the transient wavelength stabilization of the laser source using fiber Bragg grating feedback. In operation, a laser diode (10) has an output intensity centered at a peak wavelength which is responsive to a control signal. First (17) and second (18) fiber Bragg gratings are coupled to the laser diode. The first fiber Bragg grating having a reflectivity centered about a first wavelength and the second fiber Bragg grating having a reflectivity centered about a second wavelength different from the first wavelength. Each of the first and second fiber Bragg gratings (FBG) generates a feedback signal responsive to the reflectivity of the fiber Bragg grating and the output intensity of the laser diode. A controller connected to the laser diode generates a control signal responsive to the feedback signals from the first and second fiber Bragg gratings so that the peak wavelength of the laser diode is maintained at a fixed wavelength between the first and second wavelengths. The illustrated configuration may not be a vibration-resistant structure which, in turn, may lead to unsatisfactory wave-stabilization. Like the structure of FIG. 1, the configuration of FIG. 2 is neither cost-effective nor labor-effective due a plurality of FBGs. ² U.S. Pat. No. 6,058,131

A need therefore exists for a laser system with a simple and cost-effective assembly operative to dynamically adjust, a transient wavelength of laser's output to the known wavelength peak spectral line by achieving the uniformity of transient photocurrent curves produced by respective consecutive light impulses absorbed in the vicinity of the peak line.

A further need exists for a method of locking a transient wavelength of the laser's radiation on the known peak spectral line located within a range of transient wavelength.

### SUMMARY OF THE INVENTION

These needs are satisfied by the presently disclosed structure which includes a laser module with a laser emitting a transient line varying within a certain range, a wavelength-selective element, an external photo-detector and a feedback loop with a controller. The wavelength-selective element is configured with a spectral peak line selected to be within the range of the transient wavelength. The light applied to the wavelength-selective element, when processed in the vicinity of the peak line and further converted into an electrical signal, is characterized by a transient photocurrent or photovoltage curve which is indicative of the degree of light loss around the peak line.

The inventive concept is, thus, based on the processing transient photocurrent curves until the parameters of respective curves are continuously reproduced. In accordance with one disclosed implementation of the concept, the first calculated curve corresponding, for example, to an initial light impulse, becomes a reference value; all subsequently measured curves are measured based on the reference value. The measurement may include the integrated value of the curve before/after maximum light absorption in or light reflection from the wavelength-selective element, or differentiation (derivation) of the curve along the end region thereof. In a further aspect, a maximum amplitude of transient component is calculated, maintained and locked. A substantial uniformity of the measured curves based on the integrated, differentiated or maximum amplitude loss values relative to the level of the generated photocurrent when the absorption is either nonexistent or insignificant because of the deviation of the transient lasing wavelength of the laser off the peak spectral line. The uniformity indicate that the operating conditions of the laser have reached a stable level i.e., the transient wavelength is locked on the known peak absorption line. The operating conditions affecting the stabilization of the lasing wavelength include injection current and temperature. The modulation of the operating conditions is effected by switching the injection current or temperature between two fixed, but different levels.

One aspect of the disclosure includes a laser system configured with the wavelength-selective element which is one of a gaseous, fluid, solid, plasma, chemical medium or a fiber Bragg grating. The waveguides each are configured as an optical fiber or bulk optics with a spectral peak line selected to be in the varying range of the transient lasing wavelength. The coupling of the laser output into the medium generates a photocurrent processed by a controller. Once any, for example, first transient photocurrent curve that represents the degree of the laser output's absorption near the known line is obtained, it is stored as a reference value. The unfavorable comparison between subsequently measured and reference curves generates a control electrical signal applied to an injection current or temperature drivers so as to adjust either current or temperature which effects the laser's output. The lasing wavelength is locked once the subsequently-measured curves substantially match the reference curve. In other words, the transient wavelength is locked on the known peak absorption line when the form of the reference curve is continuously reproduced. Alternatively, the wave-selective component includes a fiber with a fiber Bragg grating having a resonant frequency closed to the desired lasing wavelength.

The inventive fiber laser system may be configured as a communication laser system periodically transmitting information signals generated by a laser source. The tuning of the laser source in accordance with the inventive concept occurs during the intervals between the information signal transmissions.

A further aspect of the inventive concept includes a method for dynamically adjusting the laser-operating, conditions effecting the stability of the lasing wavelength. The method is realized by controllably switching a controller output between two different levels subsequently applied to either a current driver or a temperature driver. As the intensity of photocurrent, which is generated upon coupling of the laser output into a wavelength-selecting medium varies in accordance with two different, but fixed levels, an initially measured transition photocurrent curve is stored in the controller as a reference curve. Subsequently measured transient photocurrent curves are each compared to the initially stored curve. The continuous reproducibility of the reference curve indicates the stability of the lasing wavelength.

### BRIEF DESCRIPTION OF THE. DRAWINGS

The above and other needs, features, and advantages will become more readily apparent from the following specific description illustrated by the drawings in which:

FIGS. 1 and 2 show respective diagrammatic configurations of the known Prior Art operative to stabilize a laser output at a desired frequency.

FIG. 3 illustrates an embodiment of the disclosed laser system operative to dynamically adjust the wavelength of a laser.

FIG. 4 illustrates the principle of operation of the disclosed laser system.

FIG. 5 illustrates another embodiment of the disclosed laser operative to dynamically adjust a lasing wavelength of laser.

FIG. 6 illustrates the sequence of signal transmitting and wavelength-adjusting stages of operation of the disclosed system.

FIG. 7 illustrates the tuning process of the disclosed laser system operating at 1648.23 nm wavelength.

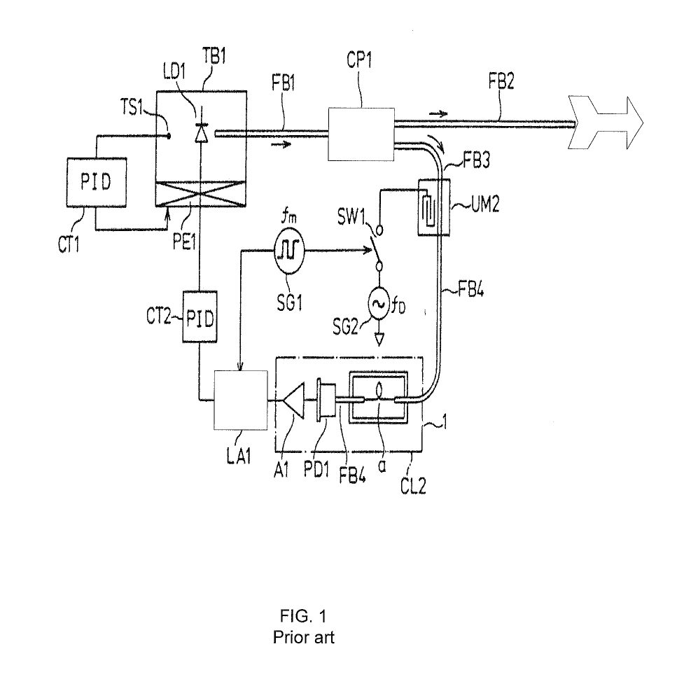

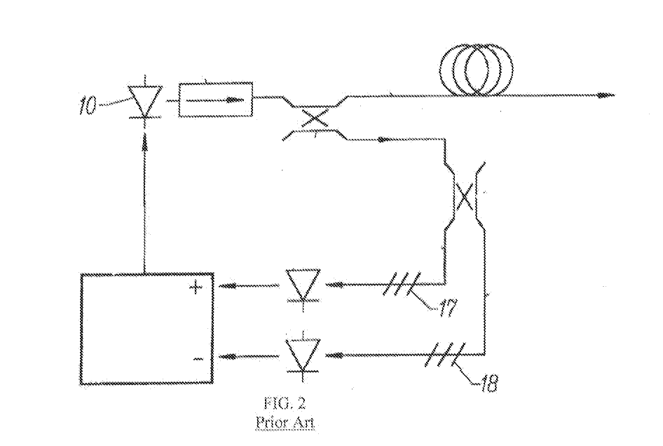

### SPECIFIC DISCLOSURE

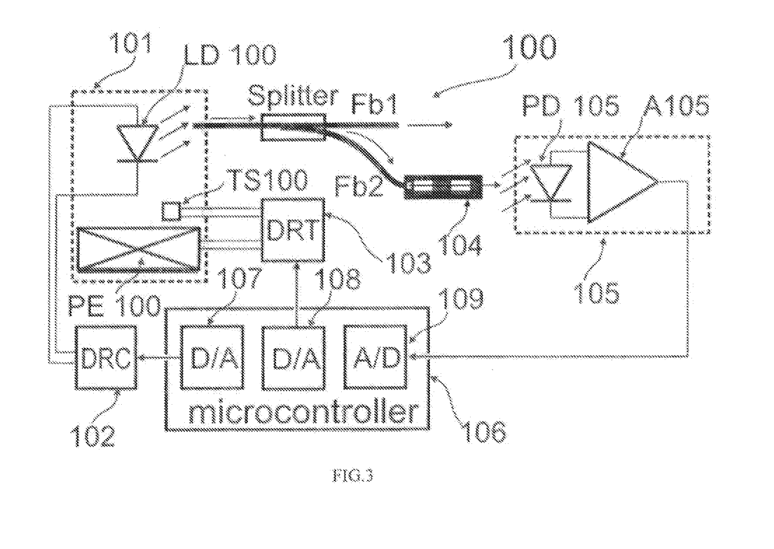

FIG. 3 illustrates a disclosed laser system 100 provided with an assembly which is operative to dynamically adjust operating conditions of a laser LD 100 so as to have a stabilized transient wavelength. Due to the temperature changes of a laser module 101, laser LD 100 often radiates light at a transient wavelength drifting within a certain range. In accordance with the disclosed concept, the locking of the transient wavelength is based on the continuous reproducibility of parameters of transient components of respective responses of a wavelength-selective element 104 to the interaction between the latter and the lased light pulses. The responses each include a light signal at the output of element 104 which is then converted into a photocurrent signal. The converted transient component is indicative of the interaction of each light pulse with the medium of element 104 around a spectral peak line of the latter. The peak line is selected to be spectrally close to the transient wavelength.

The absorption of light around the peak line is conducted by periodically switching the control signal from a controller 106 between high and low levels which are consecutively applied either to a current driver DRC 102 or temperature driver 103. The transient components are repeatedly generated based on the preset period of time necessary for the laser radiation to reach the spectral peak line. Subsequently, each transient component or its parameter is compared to parameters of a reference value. If the compared measured and reference parameters do not substantially match each other, the injection current applied directly to laser LD 100 and/or ambient temperature in module 101 are controllably modified until the reference value is repeatedly reproduced.

The laser module 101 further includes a thermoelectric pump PE 100 based on the Peltier effect. The PE pump 100 is a semiconductor heat pump that moves heat from one side of the device to the other. Depending on the direction the current flows through pump PE 100, it can either heat or cool laser diode LD 100. Completing the configuration of module 101 is a thermo-sensor TS 100 sensing the temperature within the module. Several types of temperature sensors may be used. Thermistors, I.C. sensors, and platinum resistive temperature devices are just a very few exemplary structures.

The output of laser LD 100 is coupled into a first waveguiding element, such as fiber Fb1 provided with a splitter, well known to one of ordinary skills in the laser arts, which has preferably, but not necessarily a fiber configuration. The splitter is operative to branch a portion of the laser's output, which typically, but again not necessarily, constitutes a small fraction off the output light. The branched portion, further referred to as a control light signal, propagates along a second waveguiding element, such as fiber Fb2 and, when emitted from the output end of this fiber, is coupled into wavelength selecting element 104 which is configured with any of a gaseous, fluid, solid, plasma, chemical medium, high reflectivity fiber Bragg grating and low reflectivity fiber Bragg grating, and a combination of these, the waveguides each being configured as an optical fiber or bulk optics.

The element 104 is “seeded” to operate on the peak absorption line selected close to the transient wavelength of the laser's output. The absorption of light signal by element 104 is accompanied by an electrical signal which is sensed and further amplified by respective photodiode PD 105 and amplifier A 105 of an optoelectronic unit 105. The electrical signal is characterized by a transient component. The photodiode may be replaced by any known configuration operative to convert light into photoelectrical signal. Such an element may be, for example, the phototransistor, or another light sensitive structure. The amplified curve is coupled into controller 106 where it is digitized by an A/D converter 109, and subsequently processed so as to be stored as a reference transient photocurrent curve.

The microcontroller 106 comprises a machine-readable storage medium which contains one or more software programs for processing the received signal. The processing of any subsequent amplified photocurrent/photovoltage begins in analog-to-digital converter 109, then it is compared to the reference value stored in a comparator, not shown but well known to one of ordinary skills in the computer arts. The reference value may also be a certain equivalent real number. If the comparison is not satisfactory, as discussed below, microprocessor 106 is operative to generate a control electrical signal converted in the analog form by either of or both digital-to-analog converters 107 and 108, respectively. Then the electrical control signal is coupled to current driver DRC 102 and/or temperature driver 103 and/or both via respective drivers so as to adjust the operating conditions so that a transient wavelength is locked. The process stops when the reference value is repeatedly reproduced.

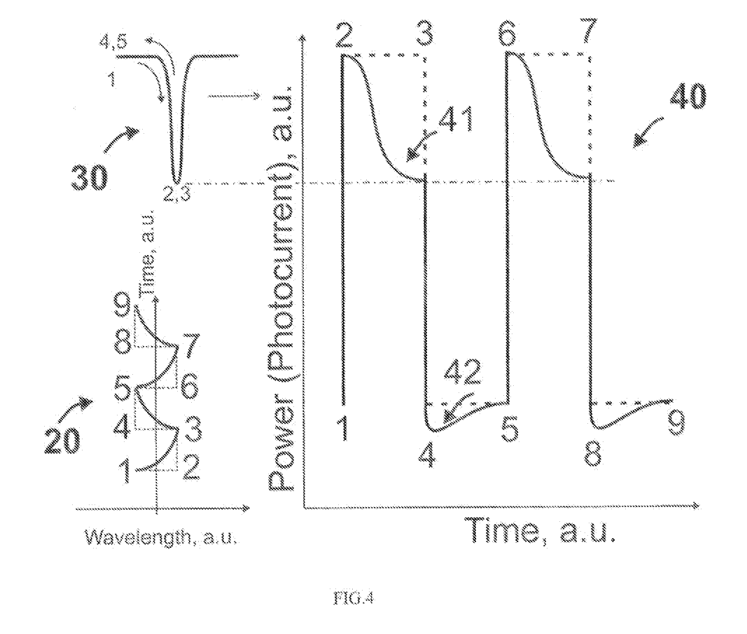

FIG. 4, discussed along with FIG. 3, illustrates the mechanism of operation of system 100 in general and controller 106 in particular. Assume that that controller 106 outputs the control electrical signal requiring current driver DRC 102 or temperature drive 103 to provide for the laser emission with a first intensity. As shown by a plot 20, the wavelength of the lased light signal exponentially grows during a moment of time 1-2. During the same moment 1-2 of plot 40, the power (photocurrent) of the lased output, which is detected by photodiode PD 105, abruptly increases. Once the wavelength of the control light signal approaches the vicinity of the peak absorption line of wavelength-selective element 104, it is being absorbed, as shown at plot 30. The absorption is manifested by a decreased power (photocurrent) in accordance with a transient component 41 at plot 40.

At the end region of transient component 41 controller 106 generates a control electrical signal or pulse corresponding to the other, low-level electrical control signal. The photocurrent, which is detected by photodiode PD 105, momentarily drops and, once the wavelength of the control light signal drifts away from the vicinity of the absorption line at the moment of time 3-4, the trend is reversed and the levels are switched again, as illustrated by a transient photocurrent curve 42. The process is repeated again and again during moments 5-6 and 7-8 until, based on electrical control signals, either the stored reference curve 41 or 42 is continuously reproduced. Note if the temperature changed momentarily, i.e. the thermal capacity of laser diode LD 100 were zero, the output wavelength of the laser diode would change as shown by dashed lines at plot 20. The phantom lines at plot 40 illustrate the character of the power change in laser system 100 if the latter would not include wavelength-selective element 104.

The mathematical model of microcontroller 106, i.e. the method of processing the curves, may include limitless algorithms. For example, integrating the initial curve and storing the integrated value of either curve 41 or 42 at plot 40. The curve 41 and 42 of course may be reproduced by measuring minimum and maximum curve's points or curve amplitude and maintaining the latter at it maximum. Advantageously, microcontroller 106 is provided with software operative to differentiate the end region of transient component 41 (or 42) right before the levels of the electric, control signal are switched. If the result of differentiation is not zero (the reference number), i.e., the current stops decreasing, the process continues so as to minimize the deviation from zero by varying the average injection current or temperature of heat pump PE100 (FIG. 3) until the reference value is repeatedly reproduced.

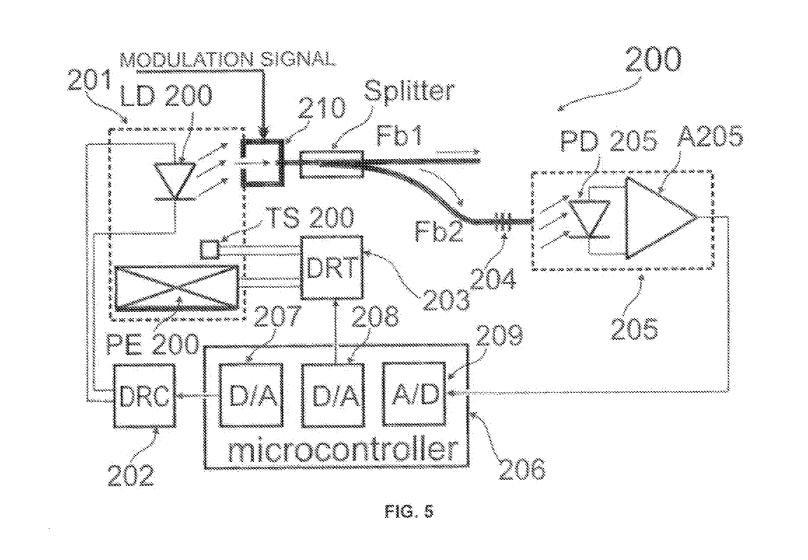

FIG. 5 illustrates a further embodiment of disclosed laser system 200. Similarly to system 100 of FIG. 3, system 200 is configured with, a laser module 201 including a laser diode LD 200, a heat pump PE 200 based on the Peltier effect and in thermal contact with the diode LD200, and a temperature sensor TS 200. During the dynamic adjustment of the transient wavelength, the emitted radiation propagates along a fiber Fb1 through a splitter 210 which is operative to branch a control light signal off the main signal. A fiber Fb2, guiding the control light signal, is configured with a fiber Bragg grating (FBG) 204 having a reflectivity which is centered about a wavelength selected close to the desired lasing wavelength. Note that FBG 204 may have a low-/high-reflectivity structure. The former can be advantageously used for data transmission if there is a need for it. As such, FBG 204 functions a wavelength-selective element 204 similar to element 104 of FIG. 3. The control light signal is radiated from the output of fiber Fb2 and coupled into a photodiode PD 205 of a photo receiver 205 transforming the control light signal into an electric signal which is amplified by an amplifier A205.

The amplified electrical signal is further received by a microcontroller 206 structured analogously to controller 106 of FIG. 3. Having a reference value stored in its comparator, as disclosed above, microcontroller 206 is operative to process the received electrical signal by first digitizing it in an analog-to digital converter A/D 209 and further using the mathematical algorithms disclosed above to reproduce a measured transient component and compare it with the reference value. If the comparison is not favorable, microcontroller generates a control electrical signal applied to a current driver DRC 202 or temperature driver DRT 203 which are operatively connected to respective laser diode LD 200 and sensor TS 200. The operation of microcontroller 206 based on the sequential application of two different levels of injection current continues until the match between the measured and reference curves is detected.

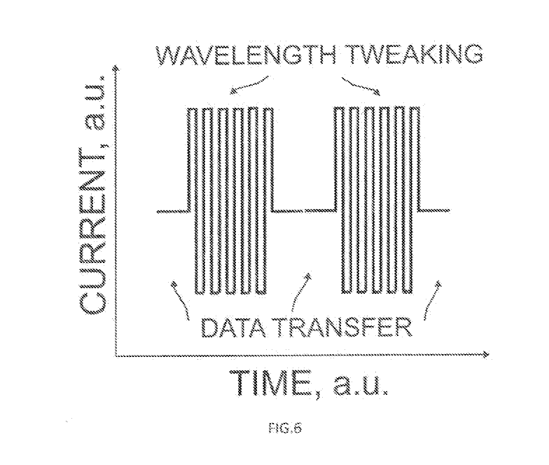

FIG. 6 illustrates the operation of a communication laser system with an external modulator that may, for example, cut the light between laser diode LD 200 and splitter, as shown in FIG. 5. The dynamic adjustment of the lasing wavelength, as disclosed in FIGS. 3 and 5, is administered between data transfer periods. Note that the current generated during the data, transfer is preferably, but not necessarily, selected to be somewhat in the middle between the high- and low-level control injection current signals used during the adjustment stage. The average injection current provides for a substantially optimal operational regime of laser diode operation during data transmission periods. The data transmission may be realized by either the external modulator or by the direct modulation as disclosed in FIG. 3 operating between the adjustment periods.

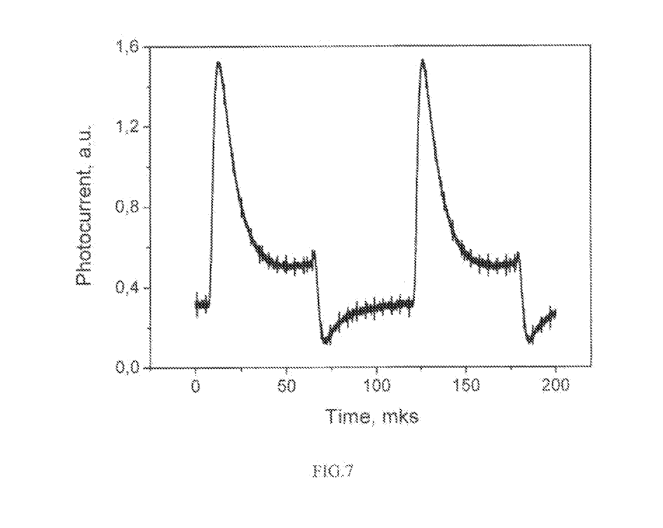

FIG. 7 illustrates experimental data obtained by the disclosed system which is configured with a laser diode OKI-OL6109L-10B. The wavelength-selective element (gas methane) is selected to contain with a peak absorption line at 1648.23 nm.

While the description above provides a full and complete disclosure of the preferred embodiments of the present invention, various modifications, alternate constructions, and equivalents will be obvious to those with skill in the art. The light may not necessarily propagate along fibers, but be guided by bulk optics. Thus, the scope of the present invention should be limited solely by the metes and bounds of the appended claims.

1. A laser system, comprising:
a laser operative to radiate consecutive light pulses at a transient wavelength varying within a range in accordance with controllable operating conditions of the laser;
a wavelength-selective element interacting with the light pulses so as to output respective light signals, the wavelength-selective element having a spectral peak line selected to be within the range of the transient wavelength;
an optoelectronic element operative to convert the light signals each into a photocurrent signal having a transient component which corresponds to the interaction of the light pulse with the optoelectronic element in a vicinity of the spectral peak line; and
a controller responsive to the photocurrent signals and operative to generate a control electrical signal which effects the operating conditions of the laser until the transient components of the respective light signals are substantially uniform which is indicative of the transient wavelength being stabilized.

2. The laser system of claim 1, wherein the controller is operative to output a plurality of consecutive alternating high and low levels of the electric control signal.

3. The laser system of claim 2, wherein the controller is operative to store one of the transient components as a reference value and compare parameters of the reference value to respective parameters of each subsequently measured transient component.

4. The laser system of claim 3 further comprising a first waveguide receiving the light pulses from the laser, a splitter optically coupled to the first waveguide and operative to branch a part of each light pulse, and a second waveguide receiving and delivering the part of light pulse to the wavelength-selective element which outputs the light signal.

5. The laser system of claim 4, wherein the optoelectronic element is configured with:
a photoreceiver operative to sense and convert the light signals output by wavelength-selective element into respective photocurrent signals, and
an amplifier operative to amplify and feedback each of the photocurrent signals to the controller, wherein the controller generates the consecutive fixed levels of the control electrical signal, which differ from one another, in response to the comparison between the parameters of respective reference value and subsequent component so as to vary the operating conditions of the laser.

6. The laser system of the claim 1, wherein the wavelength-selective element is one of a gaseous, fluid, solid, chemical medium or a fiber Bragg grating, the waveguides each being configured as an optical fiber or bulk optics.

7. The laser system of claim 5, wherein the controller is configured with an A/D converter operative to digitize the amplified photocurrent signal, and a plurality of D/A converters selectively receiving outputting the control electrical signals for changing the operating conditions of the laser after the comparison between the reference value and each transient component.

8. The laser system, of claim 7 further comprising:
an injection current driver operative to receive the fixed periodic levels of the control electrical signal from one of the D/A converters and configured to switch an injection current signal so as to have injection current signals with different amplitudes corresponding to respective fixed levels of the control signal and each applied directly to the laser, and
a thermostatic heat pump operatively connected to the laser, and a heat pump driver operative to drive the heat pump in response to the fixed periodic levels of the control electrical signal from another of the D/A drivers so as to vary a temperature at which the laser operates, wherein the operating conditions of the laser include the injection current and temperature.

9. The laser system of claim 2, wherein the controller is operative to calculate and maintain a minimal differential value of each transient component along an end region thereof before switching between the fixed levels of the control signal, the minimal differential value being about zero.

10. The laser system of claim 2, wherein the controller is operative to calculate an integrated value of each transient component.

11. The laser system of claim 2, wherein the controller is operative to calculate and maintain a maximum amplitude of each transient components which is determined as a difference between opposite extremities of the transient component.

12. The laser system of claim 1, wherein the laser is operative to provide for sequential data transmission periods alternating with periods of stabilization of the transient wavelength, the laser radiation during the data transmission being modulated by directly modulating injection current or by an external optical modulator.

13. A process of operating a laser system radiating light pulses at a transient wavelength varying within a range in response to controllable operating conditions, comprising:
coupling light pulses into a wavelength-selective medium having a peak of spectral line in the range of the transient wavelength, wherein the light pulses and medium interact with one another around the peak of spectral line;
converting the light pulses at output of the wavelength-selecting medium into respective electrical signals each having a transient component; and
sequentially processing the transient components so as to generate a control signal effecting the operating conditions of the laser until the processed transient components are substantially uniform.

14. The process of claim 13, wherein the generation of the control signal includes outputting consecutive fixed periodic levels of the control signal effecting, the operating conditions of the laser which include one of an injection current and ambient temperature

15. The process of claim 14, wherein the processing of the transient components includes storing parameters of one of the transient components, as a reference curve and comparing parameters of each subsequently measured transient components to the reference curve.

16. The process of claim 15, wherein the comparison between the reference and each subsequent transient components includes integrating each curve before or after the peak of spectral line and comparing the integrated curve to an integrating value of the reference curve.

17. The process of claim 15, wherein the comparison between the reference and each subsequent transient components includes measuring and comparing either
maximum loss of each light pulse passed through the wavelength-selecting medium of the respective reference and each subsequently measured transient components, or
minimum loss of each light pulse reflected from the wavelength-selecting medium of the respective reference and each subsequently measured transient components.

18. The process of claim 14, wherein the processing includes calculating and maintaining a minimal differential value of each of the transient components along an end region thereof before switching between the fixed levels of the control signal, the minimal differential value being about zero.

19. The process of claim 13 further comprising sequentially converting the light at an output of the wavelength-selective medium into the electrical signal, sensing and amplifying the electrical signal at the output of the wavelength-selective medium, wherein the wavelength-selective medium is selected from the group consisting of a gaseous, fluid, solid, chemical medium, high reflectivity fiber Bragg grating and low reflectivity fiber Bragg grating and a combination of these, the waveguides each being configured as an optical fiber or bulk optics.

20. The process of claim 13 further comprising providing sequential data transmissions before and after the adjustment of the transient wavelength to the peak of spectral line.
